(19) United States
(12) Patent Application Publication
(10) Pub. No.: US 2026/0279117 A1
(43) Pub. Date: Sep. 17, 2026

(54) KEYS TO A FLEET OF VEHICLES

(71) Applicant: Alan Harrison, Milford, CT (US)

(72) Inventor: Alan Harrison, Milford, CT (US)

(21) Appl. No.: 19/075,928

(22) Filed: Mar. 11, 2025

(51) Int. Cl. G07C 9/00

(52) U.S. Cl. CPC G07C 9/00309; G07C 9/00896; G07C 2009/00412; G07C 2009/00523

(57) ABSTRACT

A key to a fleet of vehicles is operable at a vehicle charging station to poll vehicles parked at the charging station and to identify an optimal next vehicle for the relay. This enables a method of traveling by a relay of vehicles from the fleet, using the key.

### BACKGROUND

The present invention relates to the electronic and automotive arts, and more specifically, to technology for vehicle leasing. It implicates and integrates a variety of apparently disparate and non-analogous concepts and technologies.

Vehicle leasing is an old field of business, generally not technological in nature. A lease transaction conventionally includes negotiation and execution of a lease agreement, payment of a deposit, and transfer of keys to a single vehicle. Although the lessor continues to own the leased vehicle, the lessee has permission to operate the vehicle (so long as they continue with timely lease payments) and a responsibility to maintain it.

The keys to modern vehicles often operate electronically, rather than by mechanical action. Many vehicles are activated by pushing a button in the presence of a radio-frequency (RF) transmitter in a key “fob” that is carried by the vehicle's operator. Each vehicle is programmed to recognize a unique RF signal transmitted by the vehicle's corresponding fob. If a key is lost, a replacement fob must be programmed to transmit the same signal. It is generally considered important that the signal for each fob-vehicle set should be unique from other sets, so that the holder of a single key is not able to operate multiple vehicles, e.g., vehicles purchased or leased by other operators. Requiring each vehicle to be activated by its own unique signal also means that a duplicated key only will be able to activate its original owner's vehicle.

Electric vehicles are becoming increasingly important as many manufacturers seek to phase out fossil-fueled vehicles. One limitation of electric vehicles is their recharge range, which can be expected to be problematic as such vehicles are more widely adopted while charging stations remain widely dispersed, small in numbers, and slow in operation. The establishment of additional charging stations presents a chicken-and-egg problem, in that without extensive government subsidies it will not be a reasonable business proposition to set up an adequate number of stations until electric vehicles are fully adopted; and without an adequate number of stations, full adoption of electric vehicles will be grudging at best and most likely infeasible. Even with adequate stations, charging time remains an issue.

The Pony Express delivered mail and news between Missouri and California via a continuous relay of fresh horses, ridden along a route of stations that were spaced from 8 miles to 25 miles apart. Riders, who kept the relay going by day and night, switched out at stages of 115 miles to 102 miles. The only control of access to the horses was by means of firearms kept at the relay stations. The Pony Express functioned for a little more than 18 months before being superseded by the telegraph. It was thoroughly unprofitable and depended on substantial government subsidies.

One frequently-requested feature of modern vehicles is a satellite radio system, in which a car-mounted receiver is operable, under a subscription model, by a satellite signal that transmits both digitized audio and also a code (e.g., a receiver identifier) that activates the receiver. The car-mounted receiver frequently is in communication with an overall car computing system.

### SUMMARY

The application discloses a key to a fleet of vehicles. Further, the application discloses a method of traveling by a relay of vehicles from the fleet, using the key. In an aspect of the disclosure, the key is operable at a vehicle charging station to poll vehicles parked at the charging station and to identify an optimal next vehicle for the relay.

In view of the foregoing, techniques of the present invention can provide substantial beneficial technical effects. For example, one or more embodiments provide one or more of:

Access to a fleet of rechargeable electric vehicles by the lessee of a single key.

Ability to travel by electric power a distance greater than the charging range of a single electric vehicle, without pausing to recharge a vehicle.

A subscription service for on-demand access to semipublic transportation.

Enhanced freedom of, and increased speed of, travel by means of electric vehicles.

Route planning for autonomous electric vehicles.

A relay of autonomous electric vehicles, with a hand-off mechanism for the relay.

A key that enables operation of an autonomous electric vehicle toward a chosen destination and that polls a fleet of autonomous electric vehicles at an intermediate waypoint to identify an optimal next vehicle toward the chosen destination.

Some embodiments may not have these potential advantages and these potential advantages are not necessarily required of all embodiments. These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 depicts an electric vehicle at a charging station.

FIG. 2 depicts, in a schematic, an example of a key that is usable for activating one, some, or all of a fleet of electric vehicles, according to an aspect of the disclosure.

FIG. 3 depicts, in a flow chart, a method of operation of the key that is shown in FIG. 2.

FIG. 4 depicts, in a flow chart, a method of operation of the key that is shown in FIG. 2.

FIG. 5 depicts, in a flow chart, a method of operation of the key that is shown in FIG. 2.

FIG. 6 depicts, in a schematic, a networked system for permitting a key, as shown in FIG. 2, to activate any of a fleet of electric vehicles to which the key is subscribed.

FIG. 7 depicts, in a schematic, an access control system of a vehicle that is representative of the fleet of electric vehicles that is shown in FIG. 6.

FIG. 8 depicts, in a flow chart, a method of operation of the access control system that is shown in FIG. 7.

FIG. 9 depicts, in a flow chart, a method of operation of the access control system that is shown in FIG. 7.

FIG. 10 depicts, in a flow chart, a method of operation of the access control system that is shown in FIG. 7.

FIG. 11 depicts, in a flow chart, a method of operation of the networked system that is shown in FIG. 6.

FIG. 12 depicts, in a flow chart, a method of operation of the networked system that is shown in FIG. 6.

FIG. 13 depicts, in a flow chart, a method of operation of the networked system that is shown in FIG. 6.

FIG. 14 depicts, in a flow chart, a method of operation of the key that is shown in FIG. 2.

### DETAILED DESCRIPTION

Advantageously, embodiments of the invention provide a multi-faceted solution to the problems associated with current electric vehicle charging range limitations. One aspect of the solution is a re-imagining of the conventional vehicle leasing paradigm, along with the provision of technological measures to support a new paradigm of a vehicle fleet subscription service. Another aspect of the solution is provision of a fleet of vehicles, available on a subscription basis, that generally remain in readiness at suitably spaced charging stations and that can be checked out from the charging stations by operators who are subscribed to the fleet.

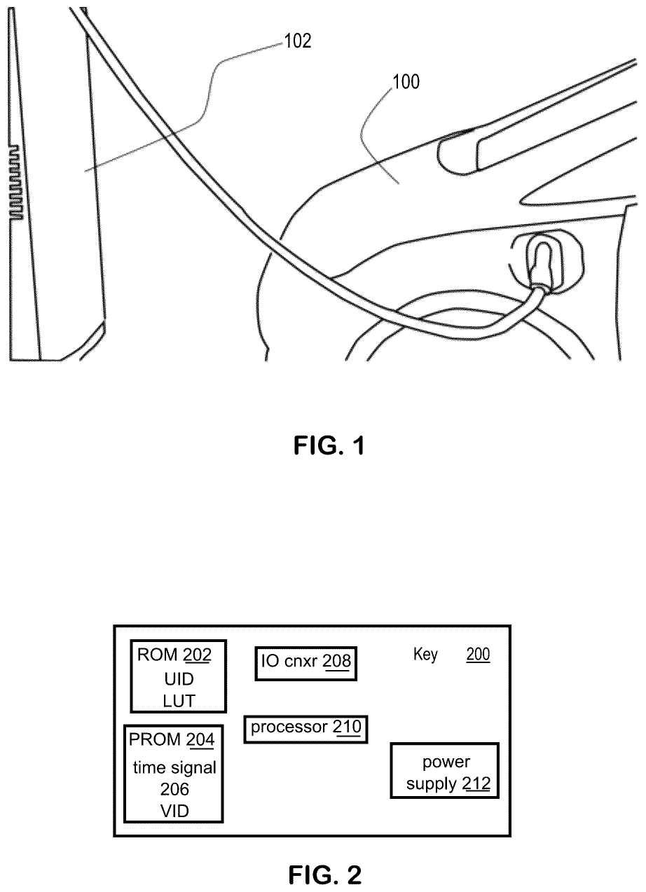

FIG. 1 depicts an electric vehicle 100 at a charging station 102.

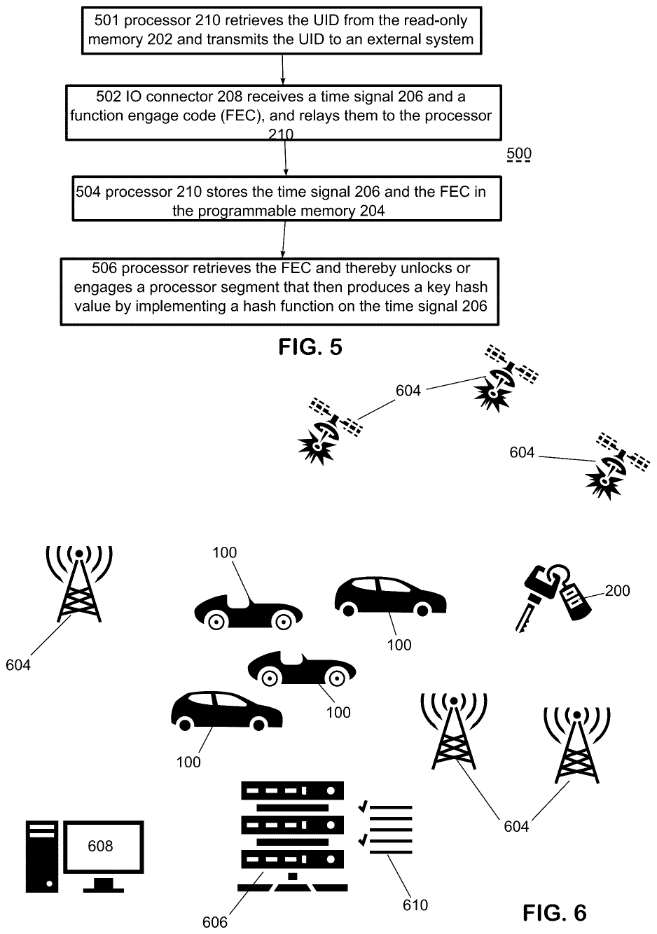

FIG. 2 depicts, in a schematic, a key 200 that is usable for activating one, some, or all of a fleet of electric vehicles, according to an aspect of the disclosure. The key 200 includes a read-only memory 202 that stores a unique key identifier (UID), one or more hash functions, and optionally a hash function lookup table (LUT); a programmable memory 204 that can store a time signal 206 and a vehicle identifier (VID); an input/output (IO) connector (e.g., a radio frequency (RF) transceiver) 208; a processor 210 that is connected in communication between the memory 202, the memory 204, and the IO connector 208; and a power supply (e.g., in one or more embodiments a battery; in one or more embodiments, a wireless charging antenna; in one or more embodiments, a set of power contacts) 212. In one or more embodiments, certain portions or segments of the processor 210 are obfuscated by techniques known to skilled workers. In one or more embodiments, operating an obfuscated portion of the processor 210 requires provision of an unlock code to the processor 210 from an external source, e.g., a function engage code (FEC) as discussed below with reference to FIG. 5.

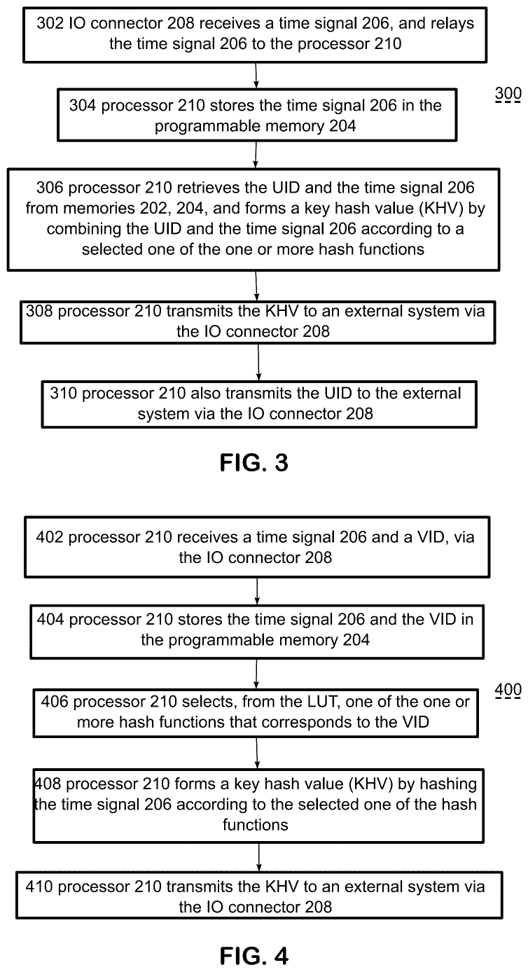

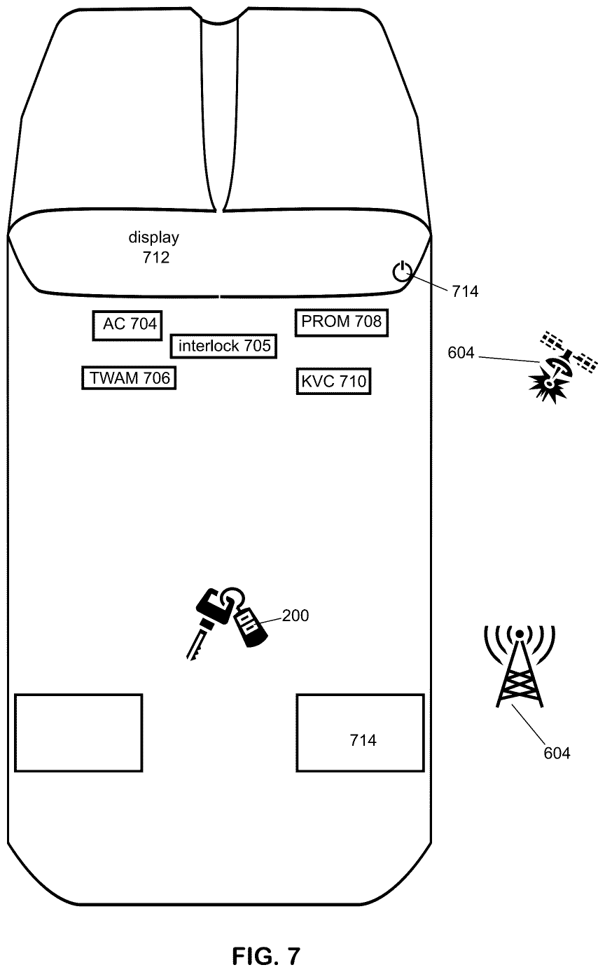

FIG. 3 depicts, in a flow chart, steps of a method 300 for operating the key 200. At 302, the IO connector 208 receives a time signal 206 from an external system (e.g., an RF communications network 604 that is discussed with reference to FIG. 6, or an access control system 700 that is discussed with reference to FIG. 7), and relays the time signal 206 to the processor 210. At 304, the processor 210 stores the time signal 206 in the programmable memory 204. At 306, the processor 210 retrieves the UID and the time signal 206 from their respective memories, and forms a key hash value (KHV) by combining the UID and the time signal 206 according to a selected one of the one or more hash functions. At 308, the processor 210 transmits the KHV to an external system (e.g., an access control system 700 that is discussed with reference to FIG. 7) via the IO connector 208. Optionally, at 310, the processor 210 also transmits the UID to the external system via the IO connector 208. Note that hashing the UID with the time signal 206 advantageously makes spoofing the key more difficult than if the method 300 relied upon transmission of the UID alone.

FIG. 4 depicts, in a flow chart, steps of a method 400 for operating the key 200. At 402, the processor 210 receives a time signal 206 and a VID, via the IO connector 208. The VID may be specific to a single vehicle, it may correspond to a vehicle category, class, model, or manufacturer, or it may be generic. At 404, the processor 210 stores the time signal 206 and the VID in the programmable memory 204. At 406, the processor 210 selects, from the LUT, one of the one or more hash functions that corresponds to the VID. At 408, the processor 210 forms a key hash value (KHV) by hashing the time signal 206 according to the selected one of the hash functions. Note that, according to the method 400, the UID is not required. At 410, the processor 210 transmits the KHV to an external system (e.g., an access control system 700 as shown in FIG. 5) via the IO connector 208.

FIG. 5 depicts, in a flow chart, steps of a method 500 for operating the key 200. At 501, the processor 210 retrieves the UID from the read-only memory 202 and transmits the UID to an external system (e.g., an access control system 700 that is discussed with reference to FIG. 7). At 502, the IO connector 208 receives a time signal 206 and a function engage code (FEC), and relays them to the processor 210. At 504, the processor stores the time signal 206 and the FEC in the programmable memory 204. At 506, the processor retrieves the FEC and thereby unlocks or engages a processor segment that then produces a key hash value by implementing a hash function on the time signal 206. Without the FEC, the processor segment for implementing the hash function is not accessible. Advantageously, according to the method 500, spoofing the key 200 can be exceedingly difficult when an FEC is used to access the hash function.

FIG. 6 depicts, in a schematic, a networked system 600 for permitting a key 200, as shown in FIG. 2, to activate any of a fleet of electric vehicles 100 to which the key is subscribed. The networked system includes one or more keys 200, the vehicles 100, a radio frequency (RF) transmission network 604, and an access control server 606 that publishes a web-enabled front end 608 and maintains a list 610 of authorized UIDs (optionally, in association with function engage codes (FECs)). The RF transmission network 604 can be implemented in various ways. For example, in one or more embodiments the RF transmission network 604 is a network of cellular telephone base stations. In other embodiments, the RF transmission network 604 is a network of Internet-capable satellites (e.g., Starlink) or media-capable satellites (e.g., Sirius XM). FIG. 6 shows both embodiments of the RF network 604 as alternative or auxiliary options. It is helpful, for certain embodiments, to use an RF network 604 that is configured for code division multiplex access (CDMA) or time division multiplex access (TDMA) protocols. For example, the method XX00 that is discussed with reference to FIG. XX can benefit from use of CDMA protocols.

FIG. 7 depicts, in a schematic, an access control system 700 of a vehicle 702 that is representative of the fleet of electric vehicles 100 shown in FIG. 4. The access control system includes an activation circuit (AC) 704, which is connected in communication with an interlock 705, a two-way activation module (TWAM) 706, a programmable memory 708, a key verification circuit (KVC) 710, a vehicle display 712 (which may be a touchscreen), and an activation button 714 (which may be implemented as one or more pixels on a touchscreen display 712). In one or more embodiments, the interlock 705 also is connected in communication between a motor controller 716 and one or more motors 718.

In operation of the access control system 700, the TWAM 706 operates as a transceiver in radio communication with the RF network 604 and the key 200. In one or more embodiments, the KVC 710 may be implemented as software in a generic processor. In one or more embodiments, the vehicle display 712 may be a dashboard mounted display as in a modern vehicle audiovisual system.

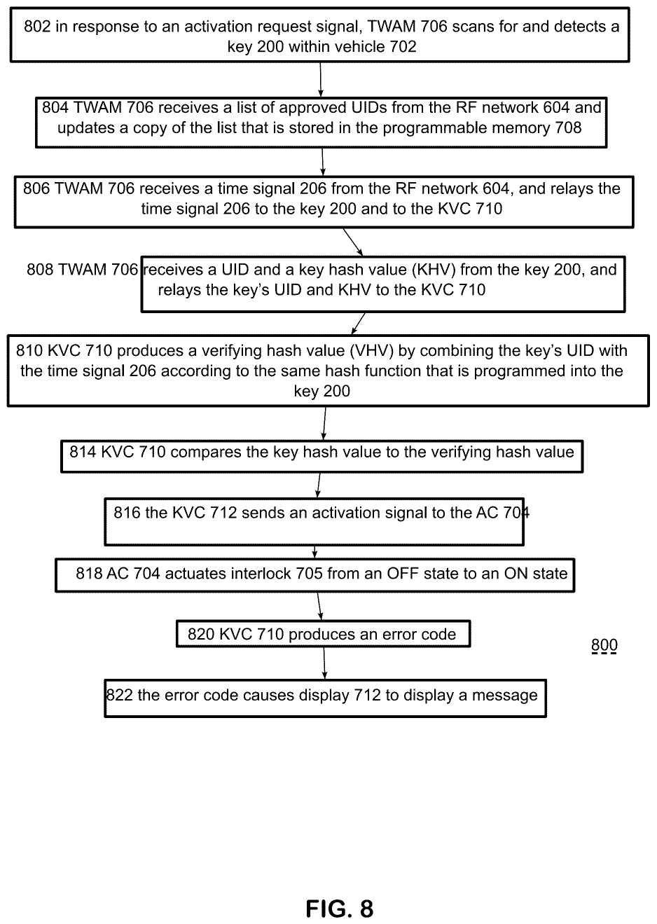

FIG. 8 depicts, in a flow chart, a method 800 of operation of the access control system 700 that is shown in FIG. 7.

At 802, in response to an activation request signal (e.g., a signal produced by the activation button 714 in response to a touch), the TWAM 706 scans for and detects a key 200 within the vehicle 702.

Optionally, at 804, the TWAM 706 receives a list of approved UIDs from the RF network 604 and updates a copy of the list that is stored in the programmable memory 708. In one or more embodiments, the list of approved UIDs is continuously streamed to the TWAM 706 by the RF network 604 and the step of updating the list in the programmable memory 708 occurs periodically, whether or not a key is present in the vehicle.

At 806, the TWAM 706 also receives a time signal 206 from the RF network 604, and relays the time signal 206 to the key 200 and to the KVC 710.

At 808, the TWAM 706 receives a UID and a key hash value (KHV) from the key 200, and relays the key's UID and KHV to the KVC 710.

In one or more embodiments, at 810, the KVC 710 produces a verifying hash value (VHV) by combining the key's UID with the time signal 206 according to the same hash function that is programmed into the key 200. A skilled worker will appreciate that the hash function is a vulnerable aspect of the access control system 700, and that the hash function can advantageously be protected by various obfuscation techniques. Hardware implementations of the hash function particularly can benefit from well-known circuit obfuscation techniques, which are within the skilled worker's purview and need not be further described for their benefit.

In one or more embodiments, at 814, the KVC 710 compares the key hash value to the verifying hash value.

If the KHV matches the VHV, then at 816 the KVC 712 sends an activation signal to the AC 704. At 818, the AC 704 then actuates the interlock 705 from an OFF state to an ON state. In the OFF state, the interlock 705 interrupts signals from the motor controller 716 to the motors 718. In the ON state, the interlock 705 transmits signals from the motor controller 716 to the motors 718. Thus, the access control system 700 operates so that the motor controller 716 is only permitted to operate the motors 718 when an authorized (subscribed) key 200 is present in the vehicle 100.

In one or more embodiments, the interlock 705 includes a power transistor. In one or more embodiments, the interlock 705 includes a solenoid relay. A skilled worker will apprehend equivalent devices for implementing the interlock 705.

On the other hand, if the two hash values do not match, then at 820 the KVC 710 produces an error code. In one or more embodiments, at 822 the error code causes the vehicle display 712 to display a message such as “PLEASE SCAN THE QR CODE TO RENEW YOUR SUBSCRIPTION.” In one or more embodiments, such a message includes a QR code that can be scanned with a mobile device to access a subscription storefront.

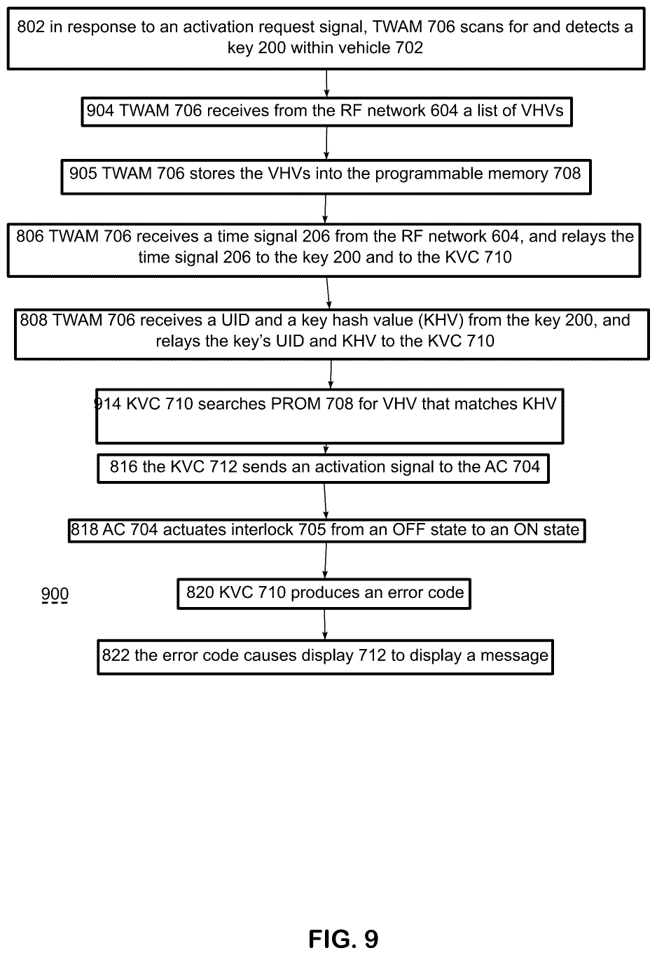

FIG. 9 depicts, in a flow chart, another method 900 of operation of the access control system that is shown in FIG. 7. Many of the steps in the method 900 are identical or nearly identical to those of the method 800; steps shown in FIG. 9 are discussed here only as they differ from those shown and described with reference to FIG. 8.

As shown in FIG. 9, at 904, the TWAM 706 receives from the RF network 604 a list of VHVs, each corresponding to one of the keys that is authorized to access all of the vehicles in the fleet or a selected set of the vehicles in the fleet (i.e., a set comprising the vehicle 100 that contains the TWAM 706). A time signal 206 marks the end of the list of VHVs. Then at 905, the TWAM 706 stores the list of verifying hash values into the programmable memory 708.

At 914, rather than producing a verifying hash value, the KVC 710 searches in the programmable memory 708 for a VHV that matches the KHV received from the key 200.

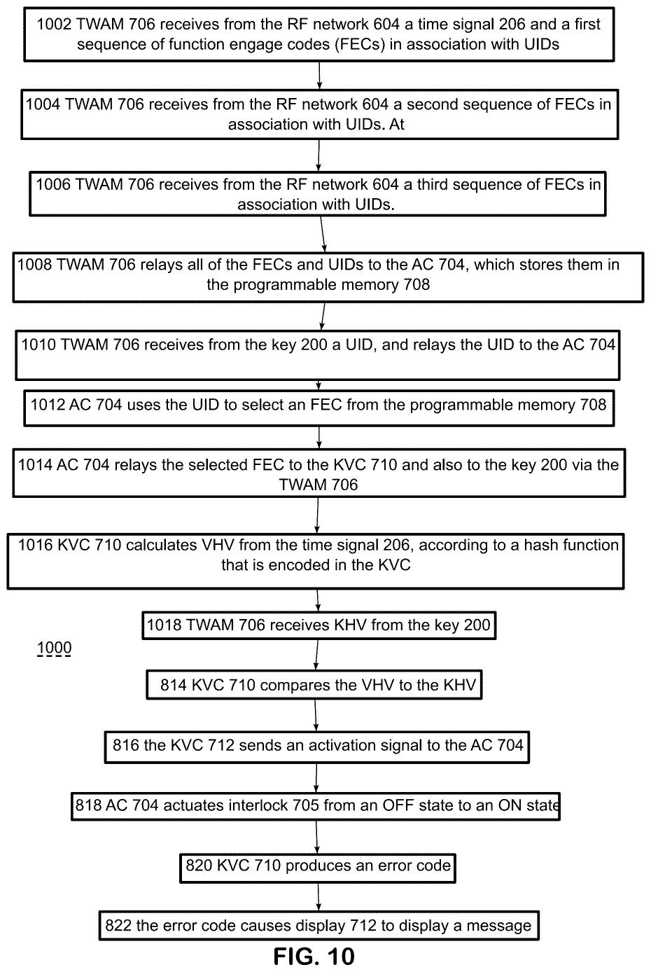

FIG. 10 depicts, in a flowchart, a method 1000 of operating the access control system 700 that is shown in FIG. 7. At 1002, the TWAM 706 receives from the RF network 604, on a first channel corresponding to “all vehicles,” a time signal 206 and a first sequence of function engage codes (FECs) in association with UIDs. At 1004, the TWAM 706 receives from the RF network 604, on a second channel corresponding to a “vehicle category” of the vehicle 100, a second sequence of FECs in association with UIDs. At 1006, optionally, the TWAM 706 receives from the RF network 604, on a third channel corresponding to the specific TWAM 706, a third sequence of FECs in association with UIDs. At 1008, the TWAM 706 relays all of the FECs and UIDs to the AC 704, which stores them in the programmable memory 708. At 1010, the TWAM 706 receives from the key 200 a UID, and relays the UID to the AC 704. At 1012, the AC 704 uses the UID to select an FEC from the programmable memory 708. At 1014, the AC 704 relays the selected FEC to the KVC 710 and also to the key 200 via the TWAM 706. At 1016, the KVC 710 calculates a verifying hash value (VHV) from the time signal 206, according to a hash function that is encoded in the KVC. At 1018, the TWAM 706 receives a key hash value (KHV) from the key 200. At 814, the KVC 710 compares the VHV to the KHV. Further steps of the method 1020 are the same as the identically numbered steps in FIG. 8.

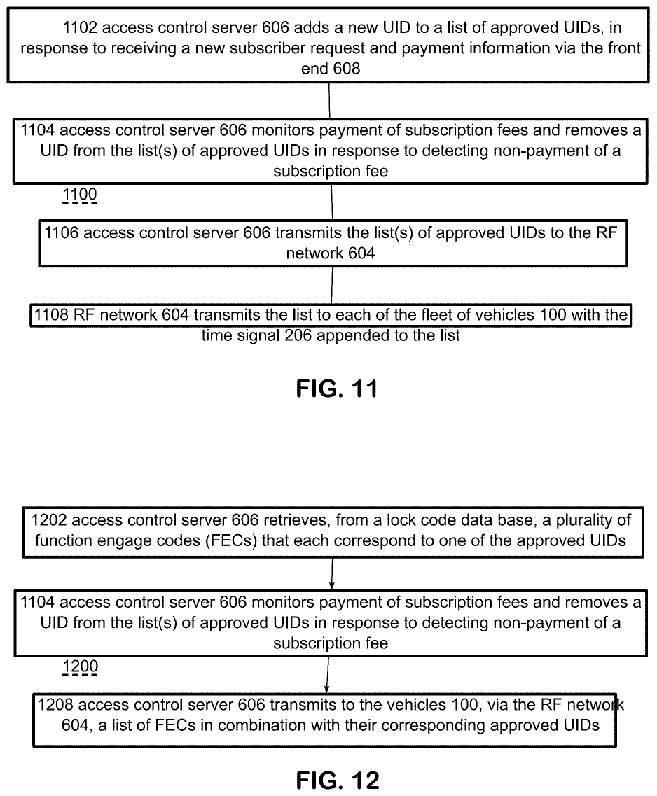

FIG. 11 depicts, in a flow chart, a method 1100 of operating the networked system 600 that is shown in FIG. 6.

At 1102, the access control server 606 adds a new UID to a list of approved UIDs, in response to receiving a new subscriber request and payment information via the front end 608. In one or more embodiments, the access control server 606 maintains a plurality of lists corresponding to different selections of vehicles from the fleet of vehicles 100, i.e. the list of approved UIDs may include several distinct lists. As examples, there may be distinct lists of approved UIDs for SUVs only, for all vehicles, for motorcycles only, for compact cars only, etc. By maintaining a plurality of lists, the access control server can reduce the size of the list sent to each individual vehicle 100 within the fleet of vehicles. For example, instead of sending a complete list of UIDs to a compact car, the access control server 606 would only need to send the “all vehicles” list and the “compact cars” list.

At 1104, the access control server 606 monitors payment of subscription fees and removes a UID from the list(s) of approved UIDs in response to detecting non-payment of a subscription fee.

In one or more embodiments, at 1106, the access control server 606 transmits the list(s) of approved UIDs to the RF network 604. Then at 1108, the RF network 604 transmits the list to each of the fleet of vehicles 100 with the time signal 206 appended to the list. In one or more embodiments, the RF network 604 uses distinct transmission channels for each of the list(s), e.g., a first channel for an “all vehicles” list, a second channel for a “compact cars only list.” Then the TWAM 706 in each vehicle 100 need only be tuned to monitor the appropriate channels, e.g., a compact car's TWAM would monitor only the “all vehicles” channel and the “compact cars only” channel. In one or more multi-list embodiments, the time signal 206 is appended only to the “all vehicles” list. In other multi-list embodiments, the time signal 206 is appended to each of the lists as an end-of-list marker.

FIG. 12 depicts, in a flow chart, a method 1200 of operating the networked system 600 that is shown in FIG. 6. Many steps of the method 1200 are identical to those of the method 1100, and accordingly are not described again. Certain steps of the method 1200 are different. For example, at 1202, the access control server 606 retrieves, from a lock code data base, a plurality of function engage codes (FECs) that each correspond to one of the approved UIDs. At 1208, the access control server 606 transmits to the vehicles 100, via the RF network 604, a list of FECs in combination with their corresponding approved UIDs. In one or more embodiments, the access control server 606 transmits a time signal 206 at the end of each list of FECs and UIDs.

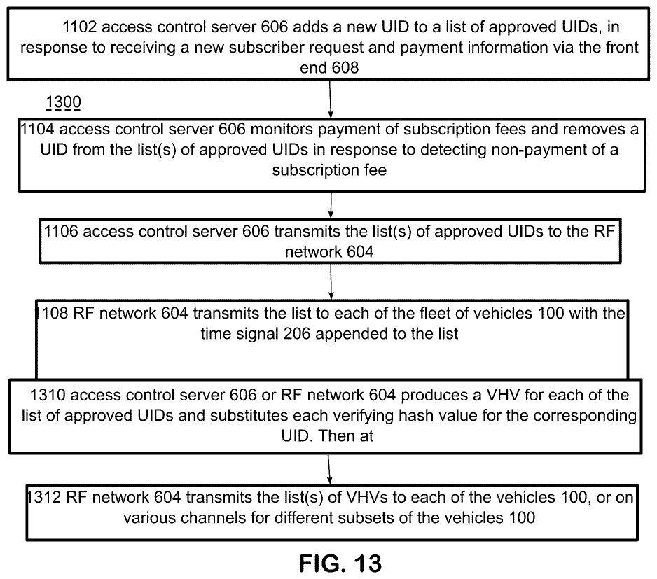

FIG. 13 depicts, in a flow chart, a method 1300 of operating the networked system 600 that is shown in FIG. 6. Many steps of the method 1300 are identical to those of the method 1100, and accordingly are not described again. Certain steps of the method 1300 are different. For example, at 1310 the access control server 606 or the RF network 604, rather than the TWAM 706, produces a verifying hash value (VHV) for each of the list of approved UIDs and substitutes each verifying hash value for the corresponding UID. Then at 1312, the RF network 604 transmits the list(s) of VHVs to each of the vehicles 100, or on various channels for different subsets of the vehicles 100. In such embodiments, the KVC 712 does not need to calculate the VHV for a given key, but only needs to search for the key's KHV in the list of VHVs received by the TWAM 706 along with the time signal 206 and stored by the TWAM 706 into the programmable memory 708.

Advantageously, the hash values are recalculated for each time signal 206, so that merely storing a single spoofed hash value into the programmable memory 708, or onto a counterfeit key, will not permit the counterfeit key to enable operation of any of the vehicles 100.

Certain aspects of the invention may incorporate measures to prevent duplication of keys or to render such duplication ineffective in attaining access to the fleet of vehicles. For example, such measures as are disclosed in U.S. Pat. No. 8,274,365 may be implemented.

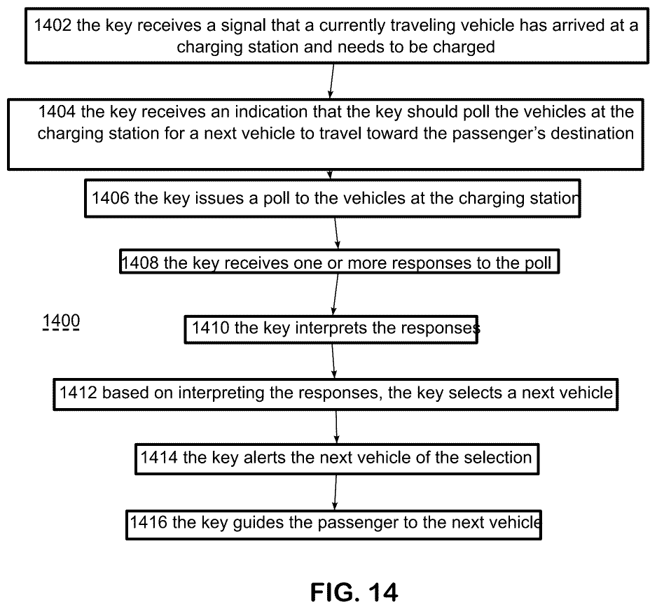

At the charging station, the key will poll the available vehicles to identify a vehicle that has a sufficient state of charge to reach the destination from the charging station, or to identify the vehicle that has the highest state of charge, or to otherwise identify the best vehicle to convey the passenger further toward the destination. FIG. 14 depicts an example polling process 1400.

Referring to FIG. 14, at 1402 the key receives a signal that a currently traveling vehicle has arrived at a charging station and needs to be charged. At 1404, the key receives an indication that the key should poll the vehicles at the charging station for a next vehicle to travel toward the passenger's destination. For example, the indication may be an indication that the current vehicle is being charged. At 1406, the key issues a poll to the vehicles at the charging station. At 1408, the key receives one or more responses to the poll. At 1410, the key interprets the responses. For example, the responses may include battery status or expected range of each responding vehicle. The key may compare the responses to a known distance to the destination. At 1412, based on interpreting the responses, the key selects a next vehicle. At 1414, the key alerts the next vehicle of the selection. In response to being alerted, the next vehicle may signal its availability to the passenger, for example, by flashing its lights, honking its horn, or otherwise making itself obtrusive. Alternatively or additionally, at 1416 the key may guide the passenger to the next vehicle.

Given the discussion thus far, it will be appreciated that, in general terms, embodiments of the invention enable a key to activate any of a fleet of electric vehicles to which the key is subscribed. Advantageously, according to a new paradigm of vehicle fleet subscription that is supported by the technological measures of this invention, it is possible for an operator in possession of a subscribed key to drive a first vehicle of the fleet from a first charging station to a second charging station, drop off the first vehicle for charging, and immediately access and operate a second vehicle of the fleet from the second charging station without waiting for the first vehicle to recharge. It also is possible for an owner of the vehicle fleet to enable or disable each key's subscription, for example, based on payments made by the registered owners of the fobs. Further, the subscribed keys can track miles driven by the operator(s) who use the fobs to access the vehicle fleet. In one or more embodiments, a key subscription can be pay-as-you-go, on a per mile basis. Alternatively, the subscription may be a flat-fee service subscription. Thus, embodiments of the invention enable enhanced freedom of, and increased speed of, travel by means of electric vehicles, while also enabling a vehicle fleet owner to profit from operating an electric vehicle relay system. It will be appreciated that, although the basic concept of a transportation relay is known, this invention provides previously unknown technological means for controlling access to such a relay, and thereby enables a profitable business in the operation of a fleet of vehicles and management of subscriptions for keys to the fleet of vehicles.

In other aspects of the disclosure, the relay of electric vehicles may be autonomous vehicles. At the beginning of a trip, a passenger may use the electronic key to select a destination and summon an initial vehicle. The key will be activated to enable operation of the initial vehicle toward the destination. If the distance to the destination exceeds the range of the summoned vehicle, that vehicle will convey the passenger to a charging station toward the destination. In some aspects, the vehicle will select the furthest charging station toward the destination. At the charging station, the key will poll the available vehicles to identify a vehicle that has a sufficient state of charge to reach the destination from the charging station, or to identify the vehicle that has the highest state of charge, or to otherwise identify the best vehicle to convey the passenger further toward the destination. Delivery of the passenger to an intermediate charging station, polling of available vehicles, and identification/selection of the best vehicle to convey the passenger further may be repeated in a relay of vehicles from the beginning of the trip to the destination. In some aspects, the key will debit the passenger's account for the full cost of the trip when the initial vehicle is summoned. In other aspects, the key will debit the passenger's account as each leg of the relay is accomplished. In other aspects, the autonomous vehicle service may be a flat-fee subscription service substantially as described elsewhere in this disclosure.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method implemented at least in part by a vehicle-mounted processor, said method comprising:
detecting presence of a key within a vehicle;
obtaining a key hash value from the key;
obtaining a verifying hash value that matches the key hash value; and
in response to the verifying hash value matching the key hash value, actuating an interlock that permits a motor controller to operate a motor of the vehicle.

2. The method of claim 1, further comprising:
obtaining a unique identifier from the key;
obtaining a time signal from a radio frequency network;
producing the verifying hash value by combining the unique identifier and the time signal, according to a hash function implemented in a key verification circuit in the vehicle; and
the key producing the key hash value by combining the unique identifier and the time signal, according to the hash function implemented in the key.

3. The method of claim 1, further comprising:
receiving the verifying hash value from a radio frequency network;
storing the verifying hash value in a programmable memory; and
matching the verifying hash value to the key hash value by searching the programmable memory for the key hash value.

4. The method of claim 3, further comprising:
the key producing the key hash value by combining the unique identifier and the time signal, according to the hash function implemented in the key.

5. A key device comprising:
a body;
a memory that stores a unique identifier;
an input output connector that receives a time signal and broadcasts a key hash value;
a processor that produces the key hash value by implementing a hash function on the time signal and the unique identifier.

6. The key device of claim 5, being implemented in a mobile personal device.

7. A method comprising:
a key receiving a signal that a currently traveling vehicle has arrived at a charging station;
the key receiving an indication that the key should poll the vehicles at the charging station for a next vehicle to travel toward a destination;
the key issuing a poll to the vehicles at the charging station;
the key receiving one or more responses to the poll;
the key interpreting the responses;
based on interpreting the responses, the key selecting a next vehicle;
the key alerting the next vehicle of the selection.

8. The method of claim 7 wherein the indication is an indication that the current vehicle is being charged.

9. The method of claim 7 wherein the responses include at least one of battery status or expected range of one or more of the responding vehicles.

10. The method of claim 9 further comprising the key comparing the responses to a known distance to the destination.

11. The method of claim 7 further comprising the key guiding the passenger to the next vehicle.

12. The method of claim 7 further comprising implementing the key in an app on a mobile personal device.

13. A system comprising:
the key device of claim 5; and
a vehicle that comprises:
a memory that stores a verifying hash value;
one or more modules that compare the verifying hash value to the key hash value and actuate an interlock in response to the verifying hash value matching the key hash value;
wherein actuation of the interlock enables a motor controller to drive a motor.

14. The system of claim 13, further comprising additional vehicles that store verifying hash values that match the key hash value.
